(19) United States
(12) Patent Application Publication
(10) Pub. No.: US 2014/0100811 A1
(43) Pub. Date: Apr. 10, 2014

(54) System and Method for Guided Laboratory Data Collection, Analysis, and Reporting

(71) Applicant: AdvanDx, Inc., Woburn, MA (US)

(72) Inventors: Martin Fuchs, Uxbridge, MA (US); James Coull, Westford, MA (US)

(73) Assignee: AdvanDx, Inc., Woburn, MA (US)

(21) Appl. No.: 14/050,854

(22) Filed: Oct. 10, 2013

Related U.S. Application Data
(60) Provisional application No. 61/712,103, filed on Oct. 10, 2012.

(51) Int. Cl. G06F 19/00

(52) U.S. Cl. CPC G06F 19/32
USPC 702/122

(57) ABSTRACT

A system and method for guided laboratory data collection, analysis, and reporting is provided. The system provides a software module with an interactive user interface for icon-based entry of test results by an operator. The system includes a computer system in communication with one or more laboratory information systems and/or one or more hospital information systems to assist in timely laboratory testing and reporting. Further, the system could also provide laboratory testing results directly to medical doctors and/or other medical professionals.

### CROSS-REFERENCE TO RELATED APPLICATION

This application claims the benefit of U.S. Provisional Application Ser. No. 61/712,103 filed Oct. 10, 2012, the entire disclosure of which is expressly incorporated herein by reference.

### BACKGROUND OF THE INVENTION

1. Field of the Invention

The present invention relates generally to software-based tools for use in medical laboratories. More specifically, the present invention relates to a system and method for laboratory data collection, analysis, and reporting.

2. Related Art

Recording laboratory data, especially medical laboratory data, requires accuracy and timeliness due to the urgency of prescribing medication or treatment to cure or relieve a patient's illness or ailment. Often, a doctor must wait for laboratory results before putting a patient on the proper medication. As a result, the quick return of laboratory testing results is essential for timely treatment of a patient.

Laboratory systems used today do not guide a laboratory technician through the recordation of visual observations of lab tests (e.g., visual assessment of microscopic bacteria), thereby leaving such data recordation prone to human error. Recordation of visual test results typically requires the laboratory technician to describe the results, which is time-intensive and prone to inaccuracy, ambiguity, and miscommunication. Tests for identifying microorganisms often require the use of a fluorescence microscope, which are usually used in a darkened room, separate from the laboratory computer terminals in the main laboratory space. As a result, laboratory operators frequently resort to recording the results of microscopic tests on paper and subsequently transcribing them into the laboratory information system. In addition to the test result, laboratories also typically require recordation of the running and examination of controls, as well as other sample parameters.

Further, accurately identifying bacteria typically requires a reference manual, which is a time-intensive resource. Still further, reporting of tests results are generally delayed because such results are usually forwarded to a hospital information system (or hospital management system) before being forwarded to a doctor, medical professional, and/or patient. Moreover, the composition of a clinical team providing treatment to a particular patient changes dynamically, so that it is often difficult for laboratory staff to determine the appropriate person to report a test result. Staff may spend a large amount of time (e.g., on the telephone) tracking down the appropriate personnel (e.g., physician, nurse, pharmacist, etc.) responsible for making treatment decisions for the patient. Additionally, access to patient records is helpful to laboratory staff interpreting a patient's test results, such as to see previous test results, medications (e.g., antibiotics) administered to the patient, etc.

Existing laboratory data collection systems are not well-equipped to guide a laboratory technician through a lab test to ensure accuracy and compliance, especially for tests requiring visual assessments. Further, existing laboratory reporting systems are not flexible enough to allow laboratory staff easy access to patient records while performing tests and interpreting test results. Still further, existing laboratory reporting systems are not sufficiently comprehensive and streamlined for accurate and fast reporting of laboratory results. Accordingly, there is a need to address these and other shortcomings of existing systems, to provide accurate and quick recording and reporting of laboratory medical test results.

### SUMMARY OF THE INVENTION

The present invention relates to a system and method for guided laboratory data collection, analysis, and reporting. The system provides a software module with an interactive user interface for icon-based entry of test results by an operator. The system includes a computer system in communication with one or more laboratory information systems and/or one or more hospital information systems to assist in timely laboratory testing and reporting. Further, the system could also provide laboratory testing results directly to medical doctors and/or other medical professionals.

### BRIEF DESCRIPTION OF THE DRAWINGS

The foregoing features of the invention will be apparent from the following Detailed Description of the Invention, taken in connection with the accompanying drawings, in which:

FIGS. 1-3 are diagrams illustrating hardware and software components of the guided laboratory data collection, analysis, and reporting;

FIG. 4 is a flowchart showing processing steps carried out by the system;

FIGS. 5-6 are screenshots showing main screens generated by the system;

FIGS. 7-9 are screenshots showing setup screens generated by the system;

FIGS. 10-16 are screenshots showing data recordation screens generated by the system;

FIGS. 17-19 are screenshots showing data reporting screens generated by the system;

FIG. 20 is a screenshot showing a records review screen generated by the system;

FIG. 21 is a diagram illustrating hardware and software architecture of the system of the present disclosure; and

FIG. 22 is a flow diagram showing processing steps for recording and reporting laboratory results using the system of the present disclosure.

### DETAILED DESCRIPTION OF THE INVENTION

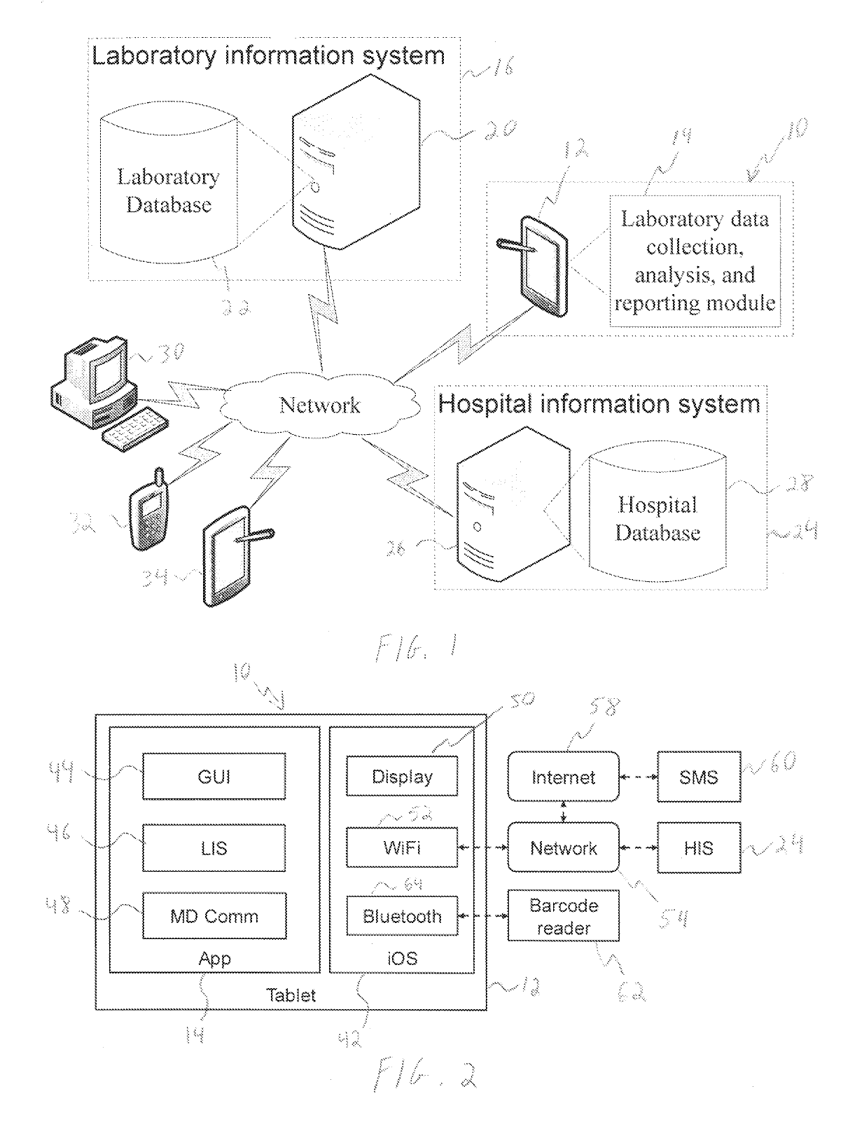

The present invention relates to a system and method for guided laboratory data collection, analysis, and reporting, as discussed in detail below in connection with FIGS. 1-22. It is noted that the system could also be used as (or in combination with) a training and certification module.

FIGS. 1-3 are diagrams illustrating hardware and software components of the laboratory data collection, analysis, and reporting system. In FIG. 1, the system is indicated generally at 10. The system 10 includes a computer system 12 having a laboratory data, collection, analysis, and reporting module (engine) 14 stored therein and executed thereby. As will be discussed in greater detail below, the module 14 guides an operator (e.g., user) through recording and reporting laboratory results. The computer system 12 could be a stand-alone computer system (personal computer) and/or one or more mobile computing devices (including, but not limited to, laptop computers, cellular telephones, smart phones (e.g., Apple iPhone, Droid smart phones, etc.), tablet computers (e.g., Apple iPad computers), etc.). The module 14 could run locally on the computer system 12. Preferably, the computer system 12 is a tablet computer with a touch screen interface, where the module 14 is accessed by way of a software application (“app”) executed on the tablet computer. Optionally, the application could be loaded from a remote database, and delivered to the operator's local computer and/or mobile communications device as files that are executed locally by the operator's device. Alternatively, the module 14 could be accessed by way of a web-based user interface accessible over a network (e.g., Internet, WAN, LAN, etc.) using a conventional web browser executed on a local computer system and/or mobile device.

The system 10 could be in electronic or wireless communication with a laboratory information system (LIS) 16 and/or a hospital information system (HIS) 24 over a network 18. Network communication could be over the Internet using standard TCP/IP communications protocols (e.g., hypertext transfer protocol (HTTP), secure HTTP (HTTPS), file transfer protocol (FTP), electronic data interchange (EDI), etc.), through a private network connection (e.g., wide-area network (WAN) connection, e-mails, electronic data interchange (EDI) messages, extensible markup language (XML) messages, file transfer protocol (FTP) file transfers, etc.), or any other suitable wired or wireless electronic communications format.

The LIS 16 is a system that receives, processes, and stores medical laboratory processing information (e.g., entering orders, receiving specimens, sending test orders to lab technicians, entering results, reporting results, etc.). The LIS 16 includes a server 20 with a laboratory database 22 stored therein. The database 22 could be located at a laboratory, or located externally (e.g., in a separate database server in communication with a laboratory server 20). The HIS 24 is a system designed to manage various aspects of a hospital (e.g., medical, administrative, financial, legal, etc.) and its service processing. The HIS 24 includes a server 26 with a hospital database 28 stored therein. The database 26 could be located at a hospital, or located remotely therefrom (e.g., in a separate database server in communication with a hospital sever 26). The system 10 could also be in communication with an electronic health record (EHR) of one or more patients.

The system 10 could communicate through the network 18 with one or more of a variety of recipients to receive laboratory orders and forward laboratory results. Those placing the orders and receiving the test results could be patients, doctors, hospital staff, etc. The recipients could receive results using any suitable electronic communication device (e.g., computer 30, cell phone or smart phone 32, a tablet computer 34, etc.). The test results could be sent directly to the recipients from the computer system. Alternatively, or additionally, the laboratory results could be sent to the LIS 16 and then forwarded to the recipients. As yet another alternative, the laboratory results could be sent to the LIS 16, then to the HIS 24, and then to the recipients. As such, there are numerous ways to structure and control the dissemination of laboratory results, depending on the needs of the users.

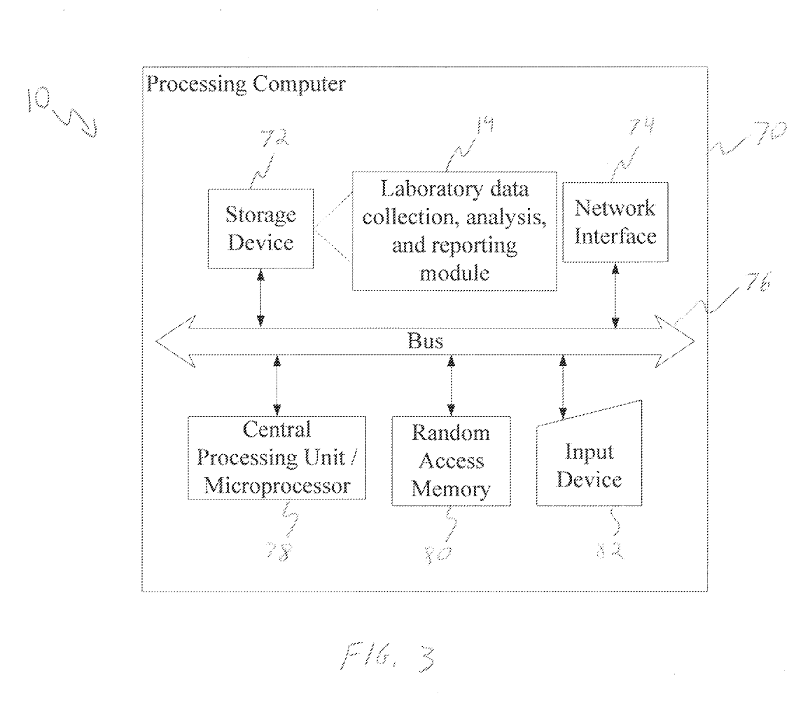

FIG. 2 is a diagram showing hardware and software components of the system 10 in greater detail. The system 10 includes a computer system 12 (e.g., a tablet computer) which includes an app 14 (i.e., laboratory reporting and recordation module) and an operating system 42. The app 14 includes a graphical user interface (GUI) 44, an LIS connectivity module 46, and a medical doctor communication (“MD Comm”) module 48. The LIS connectivity module 46 organizes and maintains information relating to laboratory testing and obtained from an LIS system (e.g., receiving information from, and sending information to, an LIS over a network). The MD Comm module 48 organizes and maintains information relating to one or more medical professionals for laboratory test reporting. The operating system could be any suitable operating system (e.g., Windows by Microsoft, Linux, iOS by Apple, etc.). The operating system could interface with a display 50, WiFi module 52, and Bluetooth module 64. The display 50 could be any suitable display (e.g., liquid crystal display (LCD), touchscreen, cathode ray tube (CRT), etc.) of any size or shape. WiFi module 52 could be used to provide network connectivity (illustrated by block 54) for communicating with the HIS 24, such as over a closed network, or could be used to communicate with medical professionals (or other recipients) over the Internet 58, such as by short message service (SMS) communication 60. Bluetooth connectivity 64 could be used to wirelessly connect with a number of medical devices, such as a barcode reader 62 (discussed in more detail below), although other wireless communication protocols and/or wired connectivity to such devices could also be used.

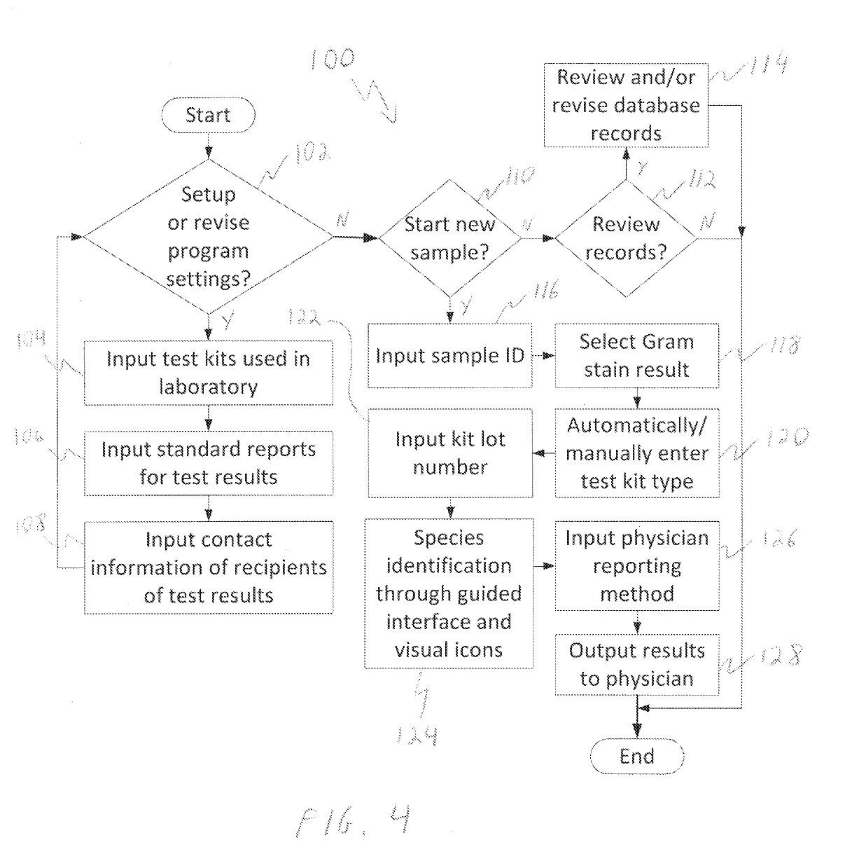

FIG. 3 is yet another diagram showing hardware and software components of the laboratory recordation and reporting system 10. The system 10 includes a processing computer (e.g., server) 70 which could include a storage device 72, a network interface 74, a communications bus 76, a central processing unit (CPU) (microprocessor) 78, a random access memory (RAM) 80, and one or more input devices 82, such as a keyboard, mouse, etc. The storage device 72 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). As mentioned above, the server 70 could be a networked computer system, a personal computer, a tablet computer, a smart phone, etc.

The module 14 could be embodied as computer-readable instructions/code stored on the storage device 72 and executed by the CPU 78 using any suitable, high or low level computing language, such as Java, C, C++, C#, .NET, MATLAB, etc. The network interface 74 could include an Ethernet network interface device, a wireless network interface device, or any other suitable device which permits the server 70 to communicate via the network. The CPU 78 could include any suitable single- or multiple-core microprocessor of any suitable architecture running any suitable operating system that is capable of implementing and running the module 14 (e.g., Intel processor). The random access memory 80 could include any suitable, high-speed, random access memory typical of most modern computers, such as dynamic RAM (DRAM), etc.

FIG. 4 is a flowchart showing representative processing steps 100 executed by the system. In step 102, an operator decides whether to setup or revise program settings. If the operator decides to do so, then the process proceeds to step 104, where the operator inputs the type of test kits that are used in the laboratory. Such test kits could include peptide nucleic acid fluorescence in situ hybridization (PNA FISH) kits, where such kits could be used for identifying Staphylococcus aureus and Coagulase-negative staphylococci (SA/CNS), Enterococcus faecalis and other enterococci (E. faecalis/OE), Escherichia coli and Pseudomans aeruginosa (E. coli/P. aeruginosa), Gram negative rods (GNR) (e.g., GNR traffic light), Candida albicans and Candida glabrata (C. albicans/C. glabrata), Yeast (e.g., Yeast traffic light), Group B Streptococcus (GBS), etc. However, alternatively, test kit input could be optional and/or automatic, and the device could comprise all currently available tests and/or test results (e.g., preliminary test results), such as by communicating with a central server for updates. Then, in step 106, the operator inputs standard reports for test results (e.g., “Positive for Staphylococcus aureus by PNA FISH: Represents Serious infections that requires aggressive therapy. Consider escalating therapy.”). In step 108, the operator enters contact information of one or more recipients of the test results (e.g., name, title, SMS contact information, email address, phone number, etc.), and could also input the preferred mode of test results reporting for each recipient. Then the process reverts back to step 102.

If, in step 102, the operator decides not to setup or revise the program settings, the process proceeds to step 110, where a determination is made as to whether to start a new sample. If the operator decides not to do so, the process proceeds to step 112, where the operator decides whether to review laboratory records. If so, the process proceeds to step 114, where the operator reviews and/or revises laboratory database records.

If, in step 110, the operator decides to start a new sample, the process proceeds to step 116 and the operator inputs a sample ID. The sample ID could be inputted by manual entry or by scanning a bar code, such as by using a bar scanner in communication with the module (e.g., Bluetooth) or a camera on the computer system. Scanning the sample ID matches the sample with the previously ordered test (or other needed information), which could be downloaded from the LIS to the computer system beforehand (e.g., batch download) or queried from the computer system to the LIS (e.g., host query). Then, in step 118, the operator could optionally select a test and/or a Multiplex test (e.g., a multiple component test) and/or a Gram stain result from an icon-based selection, such as gram positive cocci in clusters (GPCC), gram positive cocci in pairs and chains (GPCPC), GNR, yeast, etc. In step 120, to identify the species of bacteria, a test kit (e.g., PNA FISH test kit) is selected from an icon-based selection. Test kit selection could be accomplished manually by the operator or automatically by the module (e.g., automatic test kit selection based on Gram stain result input). Once the type of kit is selected, in step 122, the kit lot number is manually entered or scanned (e.g., bar scanner in Bluetooth communication). This could be used to keep an inventory of available test kits and/or to assure compliance by alerting the operator if the wrong type of test kit was scanned or entered. It is noted that the computer system need not require identification of Gram stain results or a kit test. In such circumstances, the system could be used to evaluate the results of an existing test (e.g., a preliminary test already completed) and/or to evaluate the results of a test about to be performed.

In step 124, the operator is walked through an icon-based guided interface to identify the species of the sample. In step 126, the physician reporting method is inputted, although this step could be omitted and the desired reporting method selected in the program setup along with other contact information. In step 128, the results of the laboratory test are outputted to the physician, HIS, LIS, and/or other recipients.

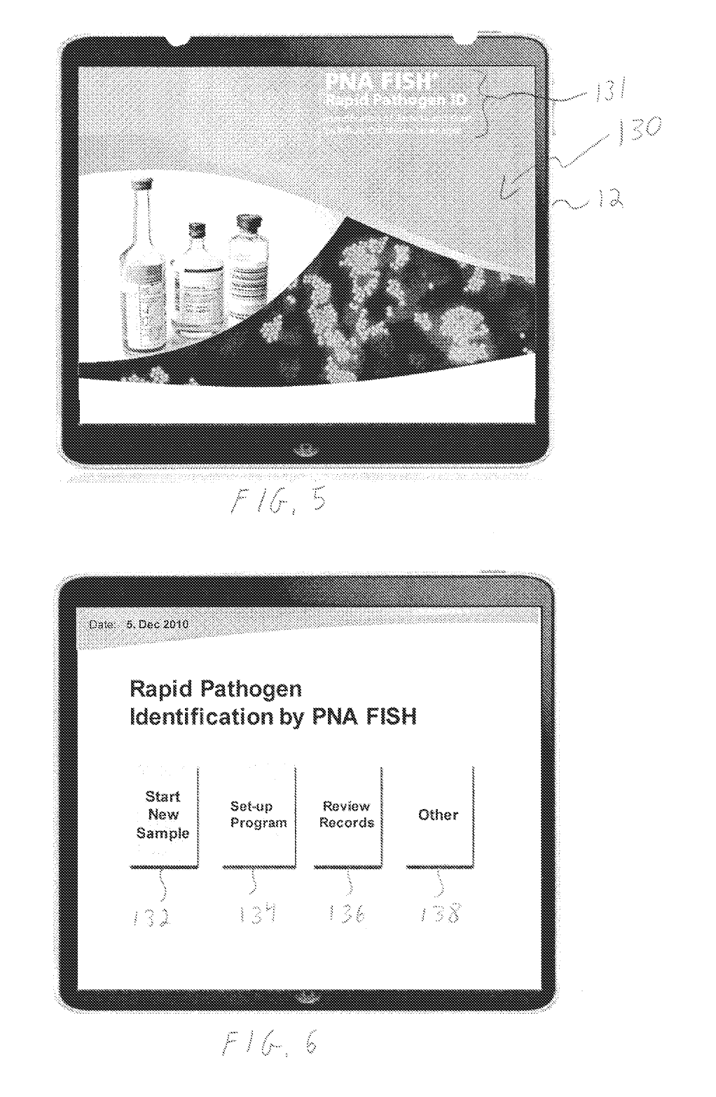

FIGS. 5-20 are screenshots of user interface screens generated by the system on a tablet computer (although any computer system could be used). Such screens could optionally be rendered as web pages displayed on the operator's local computer system and/or mobile device. They could also be rendered by a standalone, software “app” that executes on the operator's local computer system and/or mobile device.

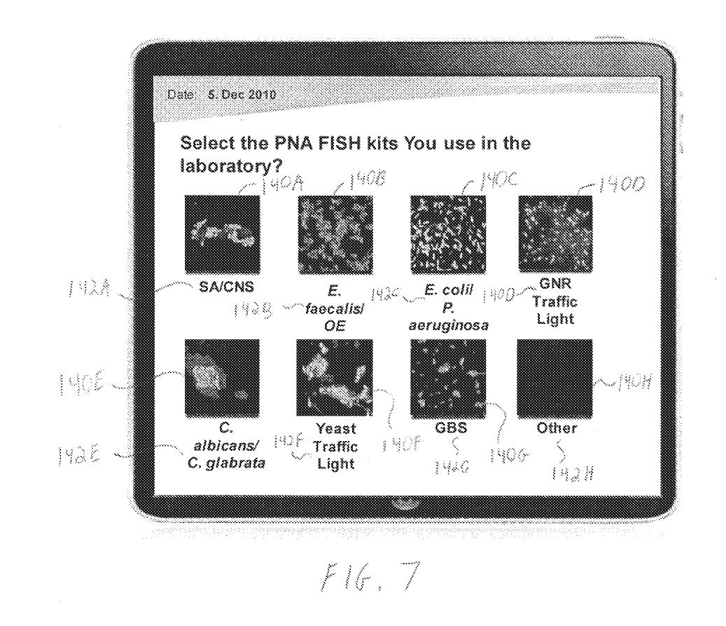

FIGS. 5-6 are screenshots showing main screens generated by the system. More specifically, FIG. 5 is a screenshot showing a title screen 130, as displayed on a tablet computer 12. As shown, the screen 130 provides information 131 about the type of tests compatible with the module (e.g., “PNA FISH Rapid Pathogen ID: Identification of Bacteria and Yeast by Whole Cell Molecular Analysis”). There could be several different apps for different types of laboratory tests, or one comprehensive app for all types of tests. FIG. 6 is a screenshot of a main screen for rapid pathogen identification providing initial options for an operator to select (e.g., start new sample button 132, setup program button 134, review records button 136, and other button 138).

FIGS. 7-9 are screenshots showing setup screens generated by the system for an operator to setup or revise program settings of the module. FIG. 7 is a screenshot of an interface allowing an operator to select (i.e., input) which test kits (e.g., PNA FISH kits) are used and available in the laboratory. As shown, the operator could be guided in selecting the test kits by visual icons 140A-H depicting the bacterial species of a particular test kit, and associated word labels 142A-H describing the bacterial species tested with a particular test kit. Here, as in other screens, the visual icons 140A-H provide a quick reference guide for the operator, which decreases the time it takes an operator to complete and record a test. Such test kits could include, but are not limited to, SA/CNS 140A, 142A, E. faecalis/OE 140B, 142B, E. Coli/P. aeruginosa 140C, 142C, GNR Traffic Light 140D, 142D, C. albicans/C. glabrata 140E, 142E, Yeast Traffic Light 140F, 142F, GBS 140G, 142G, and others 140H, 142H.

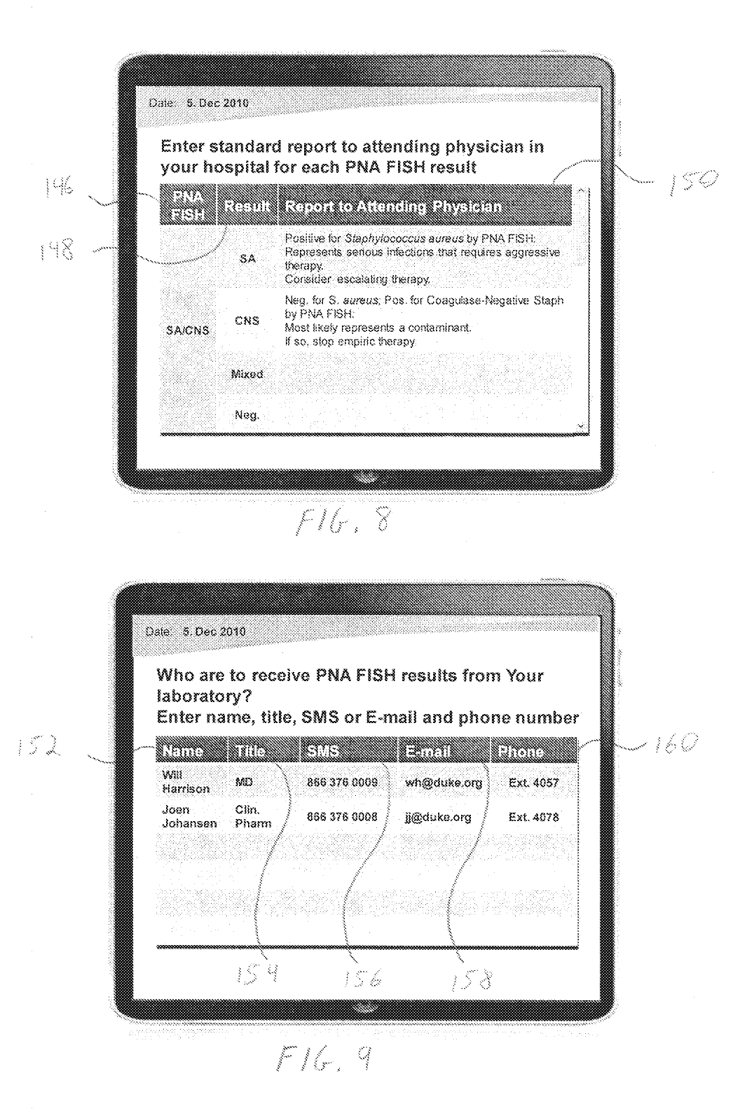

FIG. 8 is a screenshot of an interface allowing an operator to enter a standard report for a particular test result. This allows an operator to select the type of test kit 146 (e.g., PNA FISH SA/CNS kit), the result 148, and then create a corresponding standard report to one or more attending physicians 150. For example, as shown, for the PNA FISH kit for SA/CNS, there are four results: SA, CNS, Mixed, and Negative. For a positive result for SA, the standard report could read, “Positive for Staphylococcus aureus by PNA FISH: Represents serious infections that requires aggressive therapy. Consider escalating therapy.” For a positive result for CNS, the standard report could read, “Neg. for S. aureus; Pos. for Coagulase-Negative Staph by PNA FISH: Most likely represents a contaminant. If so, stop empiric therapy.”

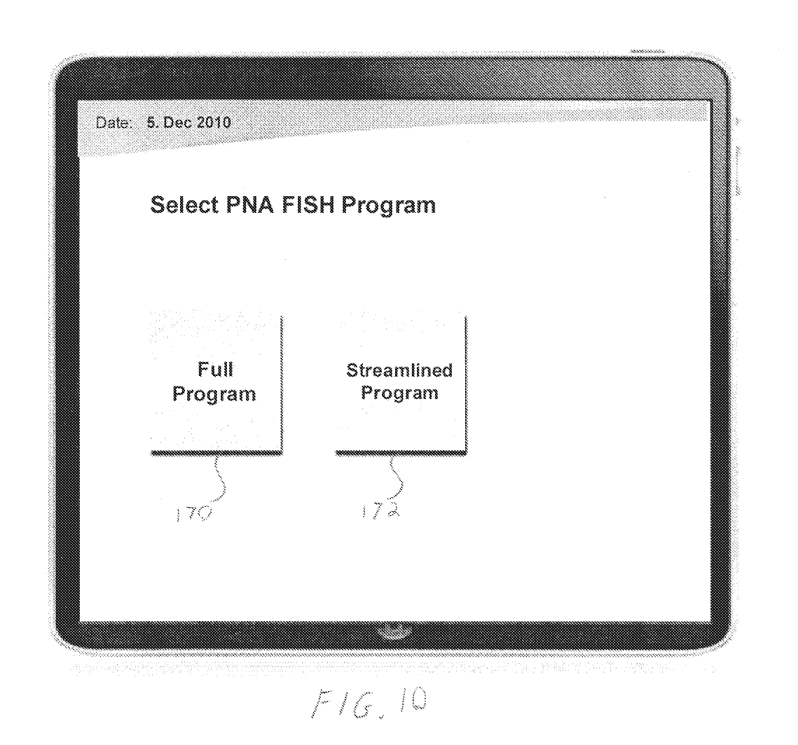

FIG. 9 is a screenshot of an interface allowing an operator to input contact information for recipients of the test results. As shown, the interface could allow an operator to input a recipient's name 152, title 154, SMS (text) information 156, email 158, and/or phone number 160, among other contact information. This information could be automatically compiled from information stored in the LIS (e.g., the physician that placed the order) or from information stored in the HIS. This is most likely to be used for common and frequent recipients of laboratory tests. For other operators, the contact information could be inputted at a later time (e.g., after the laboratory test is completed and the results recorded).

FIGS. 10-16 are screenshots showing data recordation screens generated by the system, which provide an interface to guide the operator through recording the test data and results. FIG. 10 is an introduction screen providing an operator with the option to conduct a full program by clicking button 170, or a streamlined program by clicking button 172. The difference between the programs is that the streamlined program skips certain steps based upon user pre-selection, or based upon user input as the test progresses.

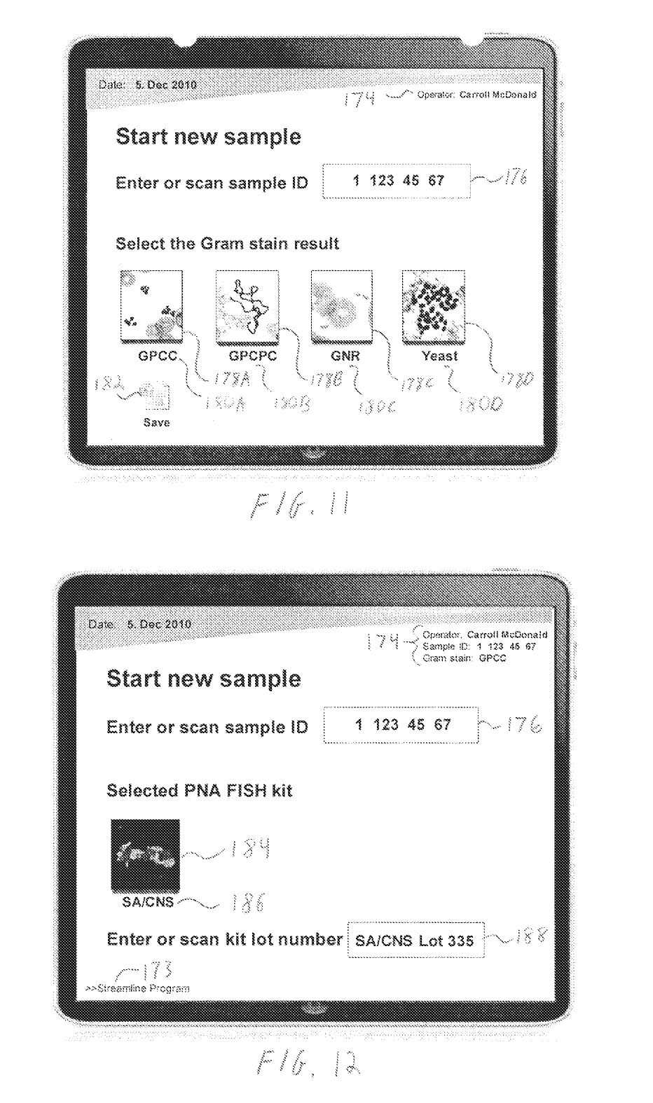

In FIG. 11 a screen is generated by the system for starting a new sample. As the process progresses, summary information 174 could be displayed in a header for an operator to easily review information (e.g., operator name, sample ID, gram stain type, PNA FISH kit lot number, etc.), particularly information relevant to multiple screens. Further, the interface could have a footer 173 to provide additional information, such as for indicating whether the streamlined program is currently being used (as shown). Additionally, an operator could use the save icon 182 to save at particular points (or at any point) in the process, and return to the test at a later time.

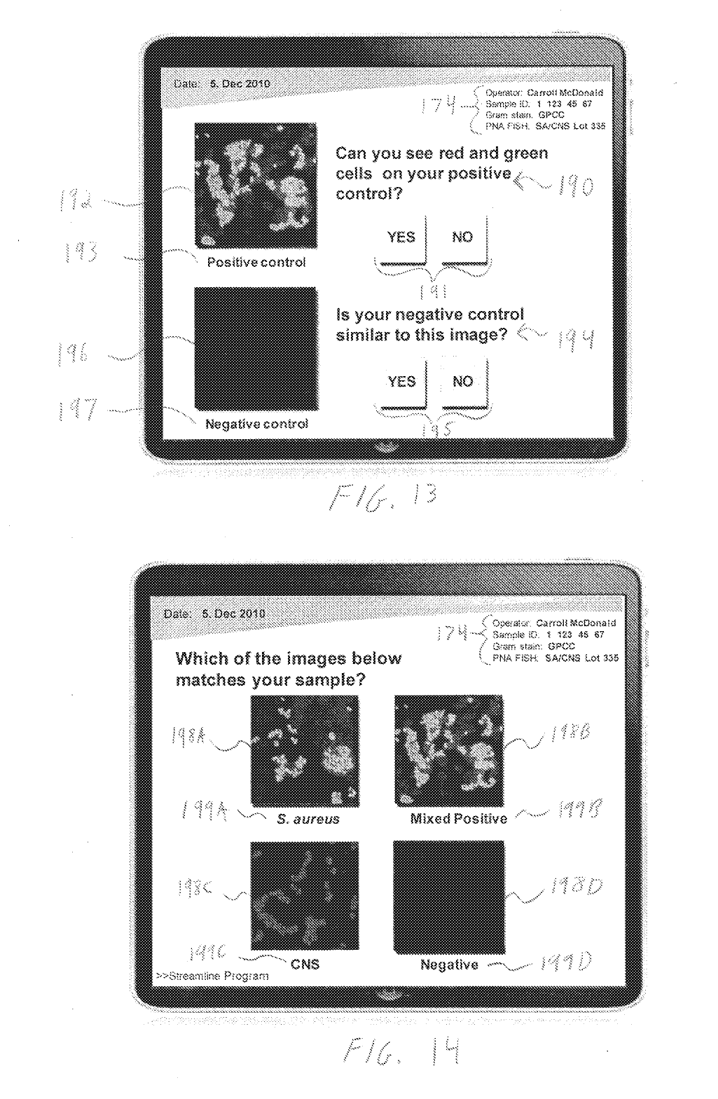

The screen generated in FIG. 11 requires an operator to input a sample ID 176, such as by manual entry or scanning (e.g., using a bar scanner). Further, an operator must select a Gram stain result, where visual icons 178A-D are shown along with associated word labels 180A-D to guide the operator through the selection. For example, as shown, an operator could select from GPCC 178A, 180A, GPCPC 178B, 180B, GNR 178C, 180C, and Yeast 178D, 180D as the Gram stain result. In FIG. 12, the operator selects, or confirms the automatic selection (e.g., auto-select based on Gram stain result), of a test kit. For example, as shown, the SA/CNS PNA FISH kit has been selected as indicated by a visual icon 184 and associated word label 186. A operator can then input the kit lot number 188, such as by manual entry or by scanning.

In FIG. 13, the questions 190, 194 (e.g., yes or no questions) are generated with associated visual icons 192, 196 and word labels 193, 197 to guide the operator through the test. The operator could answer such questions by interactive buttons 191, 195, or any other suitable input. For example, as shown, a question 190 is generated asking whether red or green cells can be seen in the positive control of the sample, with an associated visual icon 192 and word label 193, which the operator confirms or negates through interactive Yes and No buttons 191. As another example, a question is generated asking whether the operator's negative control is similar to the visual icon 196 provided, which the operator confirms or negates through interactive Yes and No buttons 195.

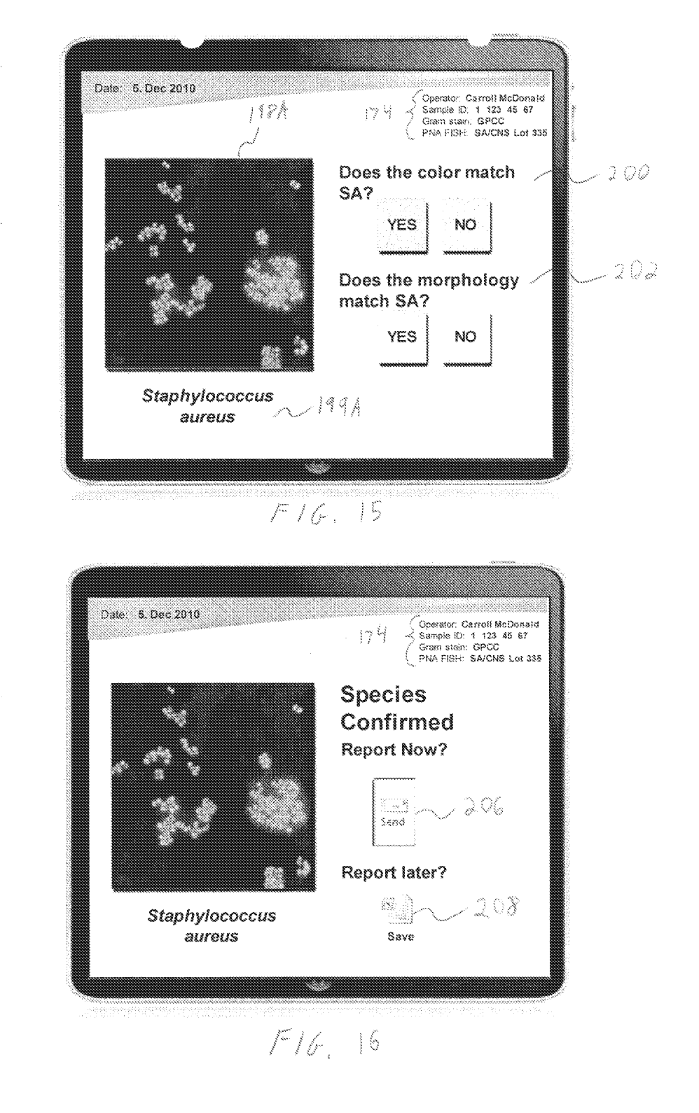

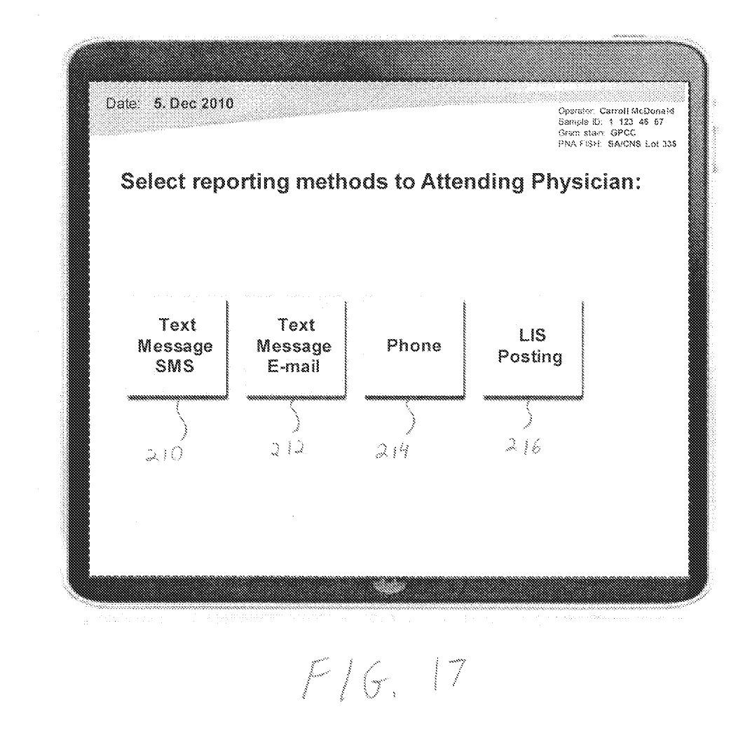

In FIG. 14, the operator chooses an image from a selection which most closely matches the sample, where visual icons and associated word labels are provided. For example, for the SA/CNS PNA FISH kit, the module could provide visual icons 198A-D and associated word labels 199A-D and require the operator to indicate which of the images provided best matches the current sample. In FIG. 15, the operator must confirm that the image selected in FIG. 14 is the species of the sample by answering the questions generated by the system. For example, as shown in FIG. 15, the module could require the operator to confirm that the color matches the species chosen in question 200, and that the morphology matches the species chosen in question 202. Once confirmed, as shown in FIG. 16, the module generates interactive icons to provide the operator with the options of reporting now by selecting icon 206, or saving and reporting later by selecting icon 208.

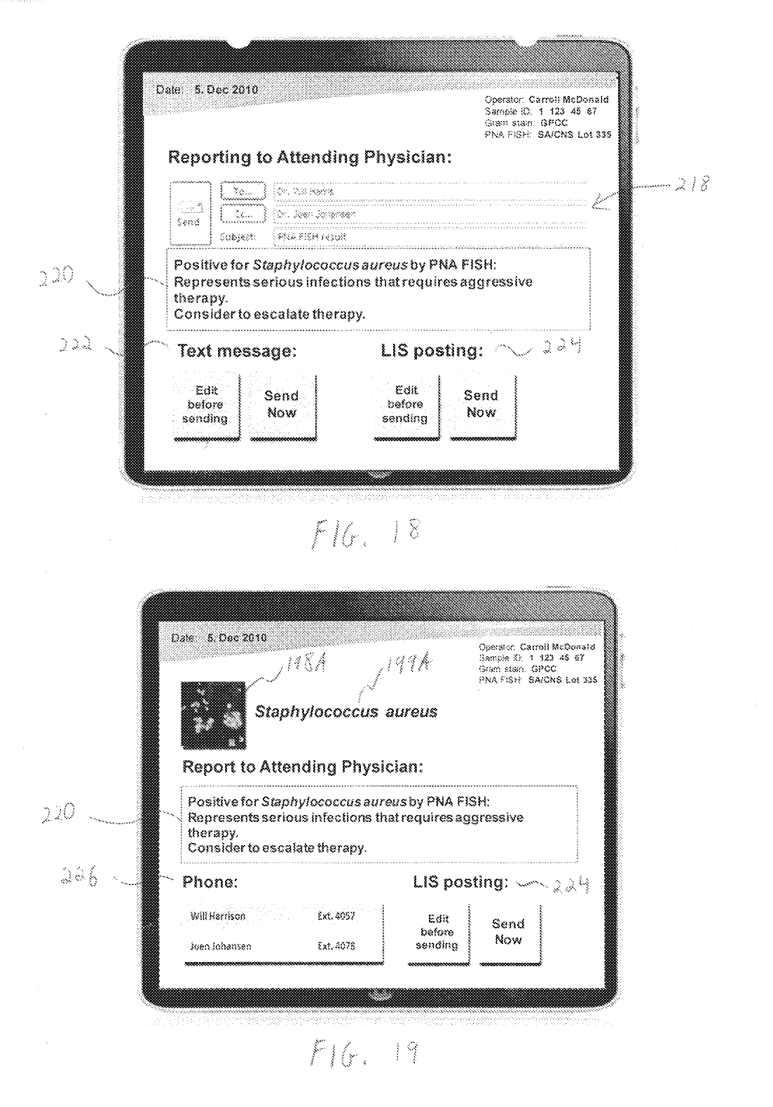

FIGS. 17-19 are screenshots showing data reporting screens generated by the system. In FIG. 17, the operator selects the reporting methods to deliver the test results to the attending physician and/or other recipients. The type of reporting method used could vary with the type and/or severity of the test results. Further, the reporting methods could be selected as part of the program setup instead, as described above. Reporting methods could be chosen by selecting text message SMS icon 210, text message email icon 212, phone icon 214, and/or LIS posting icon 216, among others.

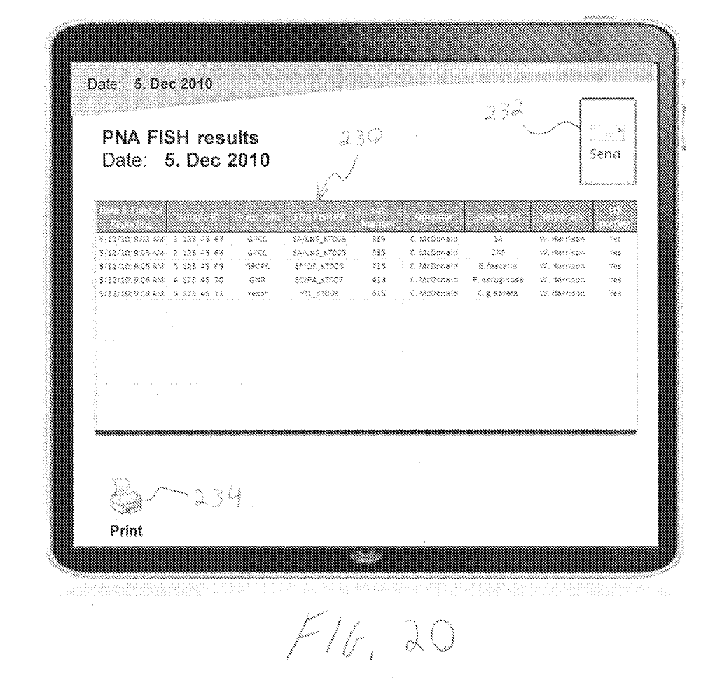

As shown in FIG. 18, the message content 220 (i.e., test results) could be automatically compiled as a standard reporting message, and the operator could review and revise the message before the results are sent. As shown, the message header 218 could include the subject, primary recipients, secondary recipients, and allow manual entry of any other desired recipients. Then the operator could confirm the method of delivery (e.g., text message 222, LIS posting 224, etc.), and send the message using one or more methods of delivery. FIG. 19 is another screenshot of the data reporting interface, showing a visual icon 198A and associated word label 199A, message 220, and potential delivery methods (e.g., phone 226, LIS posting 224, etc.).

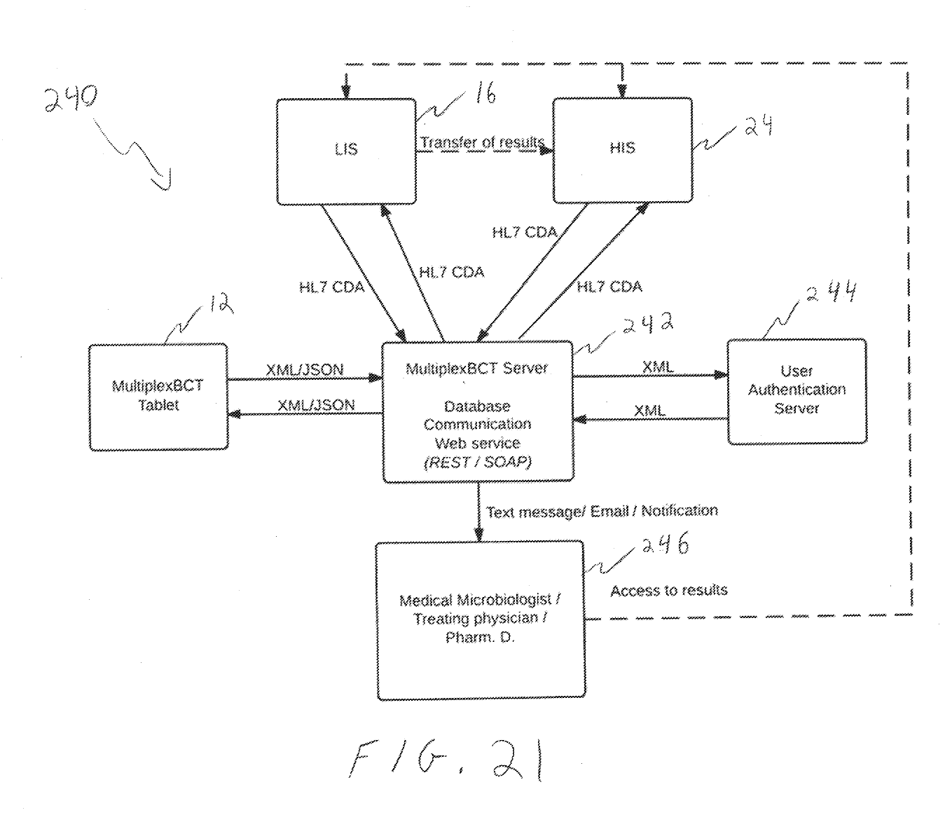

FIG. 20 is a screenshot showing a records review screen generated by the system, which displays the test results and associated information 230 (e.g., date and time of reporting, sample ID, Gram stain, PNA FISH kit, lot number, operator, species ID, physician, LIS posting, etc.). This screen could be generated based on search criteria of the operator (e.g., tests performed on a particular date, tests performed by a particular operator, etc.). This screen allows a user to send the results record screen using a send button 232, and/or print the results screen using a print button 234. Further, parts of the screen could be hyperlinked to easily filter and navigate the results.

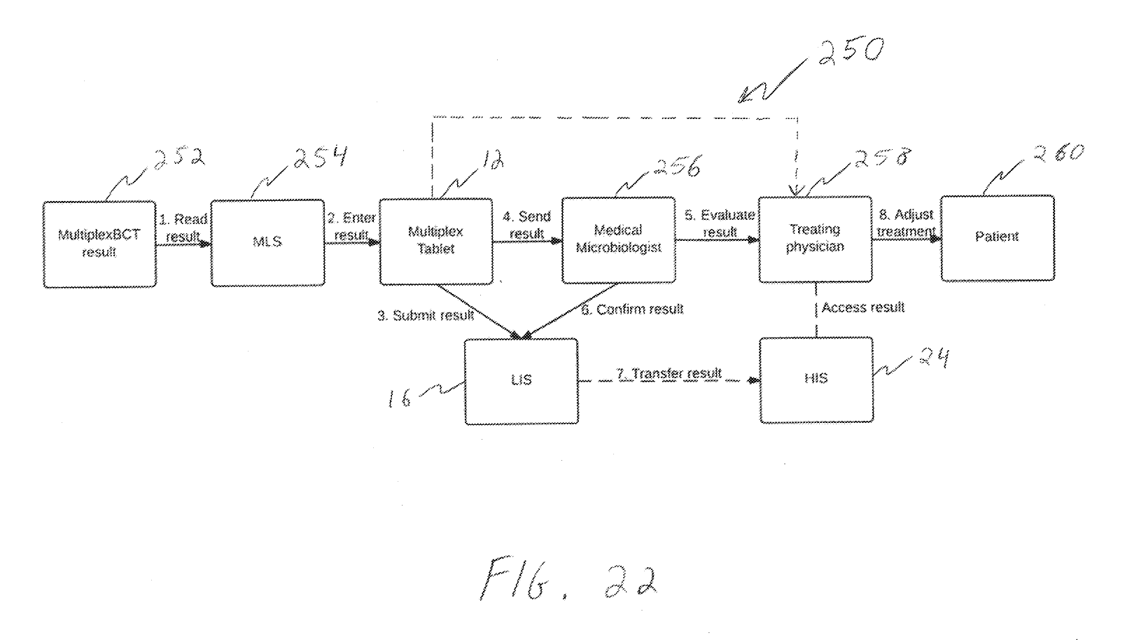

FIG. 21 is a diagram 240 illustrating hardware and software architecture of the system of the present disclosure. A server 242 using any suitable communication protocol (e.g., Simple Object Access Protocol (SOAP), Representational State Transfer (REST), XML (Extensible Markup Language), JSON (JavaScript Object Notation), etc.) is in communication with the computer tablet 12 (e.g., Multiplex Blood Culture Test (MCBT) tablet). Preferably, data is stored on the server 242 and not locally on the tablet computer 12, but could be stored on the tablet 12, if desired. The server 242 could also be in communication (e.g., via XML) with an authentication server 244, allowing a user to gain access to the system using login credentials (e.g., username and password).

The server 242 could establish and support communication with an LIS 16 and/or HIS 24 using any suitable data exchange/communication protocol (e.g., Health Level Seven Clinical Documentation Architecture (HL7 CDA)). Test results could be shared directly between the LIS 16 and HIS 24 systems. The server could communicate with an HIS 24 and/or LIS 16 to extract patient information (e.g., if available through one system but not the other). Any authorized professional (e.g., medical microbiologists, physicians, Doctors of Pharmacy (Pharm. D.), etc.) could access the results directly from the LIS 16 and/or HIS 24.

Additionally, or alternatively, the server 242 could forward (e.g., push) notifications to the authorized professional 246 through any suitable protocol (e.g., through app, e-mail, text messages, short message service (SMS), interactive voice response (IVR), etc.) and/or require acknowledgement from the medical professional 246 that the message was received (e.g., through app, e-mail, text messages, short message service (SMS), interactive voice response (IVR), etc.). In this way, the system lets users communicate laboratory results directly to the correct staff (e.g., microbiologist, physician, etc.).

There are a number of other features that the system could provide. The system could incorporate expanded quality control and data management functions (e.g., keeping track of the total number of positive and negative blood cultures, allowing for status report generation, etc.). Additionally, the system could document the operation of laboratory equipment (e.g., for proper operation), track blood volume in blood cultures, track contamination rate of blood cultures, and/or track positive and negative blood cultures. Further, the system could provide access to other patient information/data/results (e.g., through an LIS or HIS) to assist in making a diagnosis and/or selecting additional tests to perform.

FIG. 22 is a flow diagram 250 showing processing steps for recording and reporting laboratory results using the system of the present disclosure. In the diagram 250, the Multiplex result 252 (e.g., blood culture test result or any other laboratory test result) is read by the medical laboratory scientist 254 (or other laboratory technician), who enters the result in the computer tablet 12 of the system. The portability of the tablet 12 allows the scientist 254 to carry the computer tablet 12 around the laboratory, obviating the need for written notes and/or documentation. The computer tablet 12 then submits the result to an LIS 16 and/or medical microbiologist 256. The medical microbiologist 256 could then evaluate and confirm the results for the LIS 16. Further, the results could then be forwarded to a treating physician 258, and/or the treating physician 258 could simply be notified that the results are available. Although it is common in some countries (e.g., Denmark) to submit results to a medical microbiologist 256, the results could instead be sent directly from the tablet 12 to the treating physician 258, or other medical staff (e.g., through the server of the system), as is common practice in America.

The results could also be forwarded from the LIS 16 directly to the HIS 24, and the treating physician 258 (or other staff) could access the results from the HIS 24. Also, the computer tablet 12 could only submit certain test results to the LIS 16, medical microbiologist 256, and/or treating physician 258, such as only those tests that result in a positive blood culture (e.g., triggering event). Additionally, or alternatively, the system could only receive orders or requests for laboratory testing for positive preliminary testing results (e.g., positive blood cultures) performed at another location (e.g., hospital). Once the test results are transmitted and evaluated by the medical staff, they (e.g., treating physician 258) can adjust the treatment of the patient 260. All transmissions of information related to laboratory testing and/or laboratory testing results are preferably HIPAA (Health Insurance Portability and Accountability Act) compliant.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention.

1. A system for guided collection and analysis of laboratory test results, comprising:
a computer system for processing information relating to a laboratory test;
a software module stored on the computer system and generating a plurality of user interface screens for allowing a user to enter test results relating to the laboratory order and for guiding the user in providing relevant information relating to the laboratory test, at least one of the plurality of interface screens displaying at least one image for assisting the user in identifying a biological species present in a test sample; and
means for forwarding laboratory test results via a network.

2. The system of claim 1, wherein the computer system processes information relating to a laboratory test by receiving user input through a user interface of the computer system.

3. The system of claim 1, wherein the computer system processes information relating to a laboratory test by digitally receiving information from an external information system.

4. The system of claim 1, wherein the information processed comprises a positive blood culture.

5. The system of claim 1, wherein the laboratory test results are forwarded to a medical professional and the means for forwarding the laboratory test results comprises short message service (SMS), e-mail, or interactive voice response (IVR).

6. The system of claim 1, wherein the means for forwarding laboratory test results comprises electronically transmitting the results to a doctor via a network.

7. The system of claim 6, wherein the results are transmitted to a software application on a mobile device of the doctor, the software application alerting the doctor of receipt of the laboratory test results and requiring acknowledgement from the doctor of receipt of the laboratory test results.

8. The system of claim 7, wherein the software application allows the doctor to track the progress of the laboratory test.

9. The system of claim 1, wherein the computer system is a tablet computer.

10. The system of claim 1, wherein the software module is accessed by way of a web-based user interface.

11. The system of claim 1, wherein the software module further generates one or more screens to allow the user to identify a test kit used in a laboratory.

12. The system of claim 1, wherein the software module further generates one or more screens to allow the user to input standard reports for test results.

13. The system of claim 1, wherein the software module further generates one or more screens to allow the user to input contact information of one or more recipients of the laboratory test results.

14. The system of claim 1, further comprising means for inputting a sample ID into the software module.

15. The system of claim 1, wherein the software module further generates one or more screens to allow the user to select at least one visual icon to identify a Gram stain result.

16. The system of claim 1, wherein the software module requires the user to select a plurality of icons before the species of the sample is identified by the software module.

17. The system of claim 1, wherein the computer system is in network communication through an LIS connectivity module with a laboratory information system (LIS).

18. The system of claim 1, wherein the computer system is in network communication with a hospital information system (HIS) to forward the laboratory test results.

19. A method for guided collection and analysis of laboratory test results, comprising the steps of:
electronically processing at a computer system information relating to a laboratory test;
generating using a software module a plurality of user interface screens for allowing a user to enter test results relating to the laboratory order and for guiding the user in providing relevant information relating to the laboratory test, at least one of the plurality of interface screens displaying at least one image for assisting the user in identifying a biological species present in a test sample; and
forwarding laboratory test results via a network.

20. The system of claim 19, wherein electronically processing information relating to a laboratory test comprises receiving user input through a user interface of the computer system.

21. The system of claim 19, wherein electronically processing information relating to a laboratory test comprises digitally receiving information from an external information system.

22. The method of claim 19, wherein the information processed comprises a positive blood culture.

23. The system of claim 19, wherein the laboratory test results are forwarded to a medical professional by short message service (SMS), e-mail, or interactive voice response (IVR).

24. The system of claim 19, wherein forwarding laboratory test results comprises electronically transmitting the results to a doctor via a network.

25. The system of claim 24, wherein forwarding laboratory test results comprises transmitting the results to a software application on a mobile device of the doctor, and further comprises alerting the doctor through the software application of receipt of the laboratory test results and requiring acknowledgement from the doctor of receipt of the laboratory test results.

26. The system of claim 25, further comprising tracking the progress of the laboratory test by the doctor through the software application.

27. The method of claim 19, wherein the computer system is a tablet computer.

28. The method of claim 19, further comprising accessing the software module by way of a web-based user interface.

29. The method of claim 19, further comprising generating one or more screens to allow the user to identify a test kit used in a laboratory.

30. The method of claim 19, further comprising generating one or more screens to allow the user to input standard reports for test results.

31. The method of claim 19, further comprising generating one or more screens to allow the user to input contact information of one or more recipients of the laboratory test results.

32. The method of claim 19, further comprising inputting a sample ID into the software module.

33. The method of claim 19, further comprising generating one or more screens to allow the user to select at least one visual icon to identify a Gram stain result.

34. The method of claim 19, wherein the software module requires the user to select a plurality of icons before the species of the sample is identified by the software module.

35. The method of claim 19, wherein the computer system is in network communication through an LIS connectivity module with a laboratory information system (LIS).

36. The method of claim 19, further comprising forwarding the laboratory test results to a hospital information system (HIS) via a network.

37. A computer-readable medium having computer-readable instructions stored thereon which, when executed by a computer system, cause the computer system to perform the steps of:
electronically processing information relating to a laboratory test;
generating using a software module a plurality of user interface screens for allowing a user to enter test results relating to the laboratory order and for guiding the user in providing relevant information relating to the laboratory test, at least one of the plurality of interface screens displaying at least one image for assisting the user in identifying a biological species present in a test sample; and
forwarding laboratory test results via a network.

38. The system of claim 37, wherein electronically processing information relating to a laboratory test comprises receiving user input through a user interface of the computer system.

39. The system of claim 37, wherein electronically processing information relating to a laboratory test comprises digitally receiving information from an external information system.

40. The method of claim 37, wherein the information processed comprises a positive blood culture.

41. The system of claim 37, wherein the laboratory test results are forwarded to a medical professional by short message service (SMS), e-mail, or interactive voice response (IVR).

42. The system of claim 37, wherein forwarding laboratory test results comprises electronically transmitting the results to a doctor via a network.

43. The system of claim 42, wherein forwarding laboratory test results comprises transmitting the results to a software application on a mobile device of the doctor, and further comprises alerting the doctor through the software application of receipt of the laboratory test results and requiring acknowledgement from the doctor of receipt of the laboratory test results.

44. The system of claim 43, further comprising tracking the progress of the laboratory test by the doctor through the software application.

45. The method of claim 37, wherein the computer system is a tablet computer.

46. The method of claim 37, further comprising accessing the software module by way of a web-based user interface.

47. The method of claim 37, further comprising generating one or more screens to allow the user to identify a test kit used in a laboratory.

48. The method of claim 37, further comprising generating one or more screens to allow the user to input standard reports for test results.

49. The method of claim 37, further comprising generating one or more screens to allow the user to input contact information of one or more recipients of the laboratory test results.

50. The method of claim 37, further comprising inputting a sample ID into the software module.

51. The method of claim 37, further comprising generating one or more screens to allow the user to select at least one visual icon to identify a Gram stain result.

52. The method of claim 37, wherein the software module requires the user to select a plurality of icons before the species of the sample is identified by the software module.

53. The method of claim 37, wherein the computer system is in network communication through an LIS connectivity module with a laboratory information system (LIS).

54. The method of claim 37, further comprising forwarding the laboratory test results to a hospital information system (HIS) via a network.
